(19) United States
(12) Patent Application Publication
(10) Pub. No.: US 2004/0216284 A1
(43) Pub. Date: Nov. 4, 2004

(54) Exhaust system clamp

(76) Inventors: John I. Belisle, Hampton, MN (US); Wayne M. Wagner, Apple Valley, MN (US)

Correspondence Address: Merchant & Gould P.C., P.O. Box 2903, Minneapolis, MN, 55402-0903, US

(21) Appl. No.: 10/761,925

(22) Filed: Jan. 21, 2004

Related U.S. Application Data
(63) Continuation-in-part of application No. 10/462,009, filed on Jun. 12, 2003.
(63) Continuation-in-part of application No. 09/953,401, filed on Sep. 14, 2001, now Pat. No. 6,634,607.
(60) Provisional application No. 60/416,195, filed on Oct. 3, 2002.

(51) Int. Cl. F16L 33/04

(52) U.S. Cl. 24/279

(57) ABSTRACT

Clamps for sealing lap joints are disclosed. The clamps include bands each having a main body and bolts mounting flanges located at opposite ends of the main body. Sealing bars are mounted between the bolt mounting flanges of the bands. The sealing bars includes pockets for receiving portions of the mounting flanges. The pockets are defined by sealing legs and reaction legs of the sealing bar.

### CROSS-REFERENCE TO RELATED APPLICATIONS

This application is a continuation-in-part of U.S. patent application Ser. No. 10/462,009 filed Jun. 12, 2003, which claims the benefit of U.S. provisional patent application Ser. No. 60/416,195 filed Oct. 3, 2002, and is also a continuation-in-part of U.S. patent application Ser. No. 09/953,401 filed Sep. 14, 2001, all of which are hereby incorporated by reference.

### TECHNICAL FIELD

The present invention relates generally to clamps. More particularly, the present invention relates to clamps used to seal lap joints of a vehicle exhaust system.

### BACKGROUND

There are many applications where it is desirable to connect two conduits (e.g., tubes, pipes, flexible hose, ducts, etc.) together. One common application is vehicle exhaust systems. In vehicle exhaust systems, two conduits are often connected at a “lap joint.” A “lap joint” is formed by inserting the end of one conduit into the end of another conduit such that the ends overlap one another. A clamp is then placed around the overlapped ends of the conduits. The clamp preferably functions to seal the lap joint and to mechanically connect the two conduits together such that the two conduits are prevented from being pulled apart.

Numerous patents exist relating to clamps used for vehicle exhaust systems. Some example patents relating to this field include U.S. Pat. No. 4,312,526 to Cassel, U.S. Pat. No. 4,813,720 to Cassel, U.S. Pat. No. 6,116,659 to Wagner, U.S. Pat. No. 4,790,574 to Wagner et al. and U.S. Pat. No. 5,116,083 to Gillingham et al.

### SUMMARY OF THE INVENTION

The present invention relates to clamps for sealing lap joints that include fastening arrangements having fasteners that extend through sealing bars and outer reinforcing bars.

A variety of advantages of the invention will be set forth in part in the description that follows, and in part will be apparent from the description, or may be learned by practicing the invention. It is to be understood that both the foregoing general description and the following detailed description are exemplary and explanatory only and are not restricted.

### BRIEF DESCRIPTION OF THE DRAWINGS

FIG. 1A is a side view of a clamp that is an embodiment of the present invention;

FIG. 1B is a left end view of the clamp of FIG. 1A;

FIG. 1C is a right end view of the clamp of FIG. 1A;

FIG. 2A is a side view of the clamp of FIG. 1A with the fastening hardware removed;

FIG. 2B is a left end view of the clamp of FIG. 2A;

FIG. 2C is a detailed view of the flange region of the clamp of FIG. 2B;

FIG. 2D is a cross-sectional view taken along section line 2D-2D of FIG. 2A;

FIG. 3A is a front side view of a first outer reinforcing bar of the clamp of FIG. 1A;

FIG. 3B is a top view of the outer reinforcing bar of FIG. 3A;

FIG. 3C is a backside view of the outer reinforcing bar of FIG. 3A;

FIG. 3D is a left end view of the outer reinforcing bar of FIG. 3A;

FIG. 4A is a front side view of a second outer reinforcing bar of the clamp of FIG. 1A;

FIG. 4B is a top view of the outer reinforcing bar of FIG. 4A;

FIG. 4C is a backside view of the outer reinforcing bar of FIG. 4A;

FIG. 4D is a left end view of the outer reinforcing bar of FIG. 4A;

FIG. 5A is a side view of one of two retaining bars used by the clamp of FIG. 1A;

FIG. 5B is a top view of the retaining bar of FIG. 5A;

FIG. 5C is a left end view of the retaining bar of FIG. 5B;

FIG. 6A is a side view of a sealing bar used by the clamp of FIG. 1A;

FIG. 6B is a top view of the sealing bar of FIG. 6A;

FIG. 6C is a left end view of the sealing bar of FIG. 6B;

FIG. 7A is a side view of a nut bar used by the clamp of FIG. 1A;

FIG. 7B is a right end view of the nut bar of FIG. 7A;

FIG. 8A illustrates one of two bolts used by the clamp of FIG. 1A;

FIG. 8B is a left end view of the bolt of FIG. 8A;

FIG. 9 is a plan view of a band prior to being formed into a band clamp as shown in FIG. 1A;

FIG. 10 shows the clamp of FIGS. 1A-1C being used to seal a lap-joint;

FIGS. 11A and 11B illustrate an alternative clamp that is an embodiment of the present invention;

FIGS. 12A and 12B illustrate another alternative clamp that is an embodiment of the present invention;

FIG. 13 is a perspective view of a modified sealing bar that is an embodiment of the present invention, the sealing bar is adapted for use with any of the above-described clamps;

FIG. 14 is a side view of the sealing bar of FIG. 13;

FIG. 15 is an end view of the sealing bar of FIG. 13.

FIG. 16 is a top view of the sealing bar of FIG. 13;

FIG. 17 is an end view showing the sealing bar after deformation;

FIG. 18 is a perspective view of another clamp having features that are examples of inventive aspects disclosed herein;

FIG. 19 is another perspective view of the clamp of FIG. 18;

FIG. 20 is a side view of the clamp of FIG. 18;

FIG. 21 is an end view of the clamp of FIG. 18;

FIG. 22 is a perspective view of a further clamp having inventive features that are examples of inventive aspects disclosed herein;

FIG. 23 is a plan view of the band/strap of the clamp of FIG. 22 prior to pockets being formed therein;

FIG. 24 is an elevational view of the strap of FIG. 23 after pockets have been formed therein;

FIG. 25 is a partial cross-sectional view of the clamp of FIG. 22 in an assembled configuration;

FIG. 25A is a detailed view of a portion of FIG. 25;

FIG. 26 is a perspective view of a further clamp having features that are examples of inventive aspects disclosed herein;

FIG. 27 is another perspective view of the clamp of FIG. 26;

FIG. 28 is a cross-sectional view taken along one of the bolts of the clamp of FIG. 26; and

FIG. 28A is an enlarged view of a portion of FIG. 28.

FIG. 29 illustrates an embodiment of one of two bolts adapted for use with clamps in accordance with the present disclosure;

FIG. 30 illustrates another embodiment of one of two bolts adapted for use with clamps in accordance with the present disclosure;

FIG. 31A is a side view of a sealing bar for use with the bolt of FIG. 29;

FIG. 31B is a left end view of the sealing bar of FIG. 31A;

FIG. 32A is a side view of a sealing bar for use with the bolt of FIG. 30;

FIG. 32B is a left end view of the sealing bar of FIG. 32A;

FIG. 33 illustrates the bolt of FIG. 30 assembled with the sealing bar of FIGS. 32A and 32B;

FIG. 34 is side view of an embodiment of a clamp incorporating the bolt of FIG. 30 and sealing bar of FIGS. 32A and 32B;

FIG. 35 is a side view of the clamp of FIG. 34 assembled; and

FIGS. 36A, 36B and 36C illustrate yet another embodiment of a clamp having features that are examples of inventive aspects disclosed herein.

While the invention is amenable to various modifications and alternative forms, the specifics thereof have been shown by way of example in the drawings and will be described in detail below. It is to be understood, however, that the intention is not to limit the invention to the particular embodiments described. On the contrary, the invention is intended to cover all modifications, equivalents and alternatives falling within the scope of the invention as defined by the appended claims.

### DETAILED DESCRIPTION

In the following detailed description, references are made to the accompanying drawings that depict various embodiments in which the invention may be practiced. It is to be understood that other embodiments may be utilized, and structural and functional changes may be made without departing from the scope of the present invention. Further, each of the features disclosed herein can be considered stand alone inventive features or features that have inventive aspects when considered in combination with one another. In the various embodiments, like parts have been assigned the same reference numbers.

I. General Clamp Description

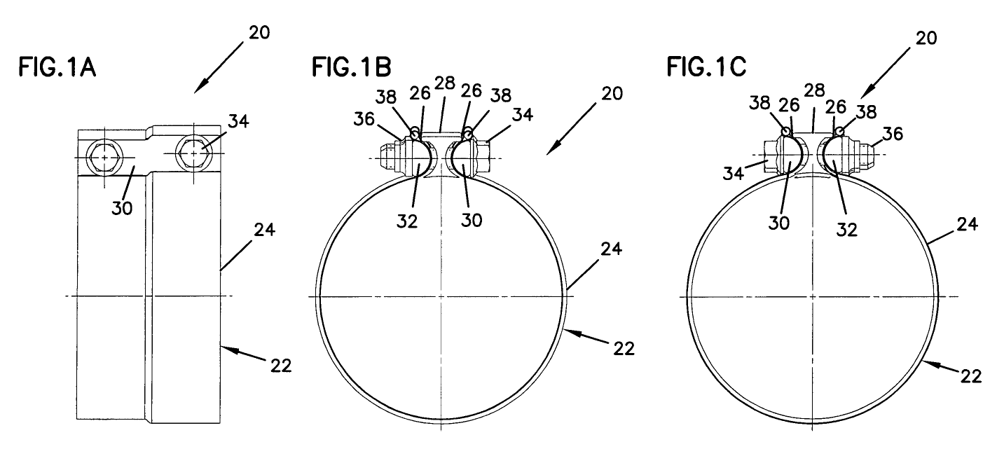

FIGS. 1A-1C illustrate a clamp 20 that is an embodiment of the present invention. The clamp includes a band 22 having a cylindrical main body 24 and bolt mounting flanges 26 that project radially outwardly from the main body 24. Retaining bars 38 are mounted at the tops of the flanges 26. A sealing bar 28 is positioned between the bolt mounting flanges 26, and outer reinforcing bars 30 and 32 are positioned outside the bolt mounting flanges 26. Two bolts 34 extend through coaxially aligned openings defined by the bolt mounting flanges 26, the sealing bar 28 and the outer reinforcing bars 30 and 32 such that the components are fastened together. The bolts 34 are threaded within a nut bar 36 positioned outside the outer reinforcing bar 32.

II. Piece-Part Clamp Description

a. Band Description

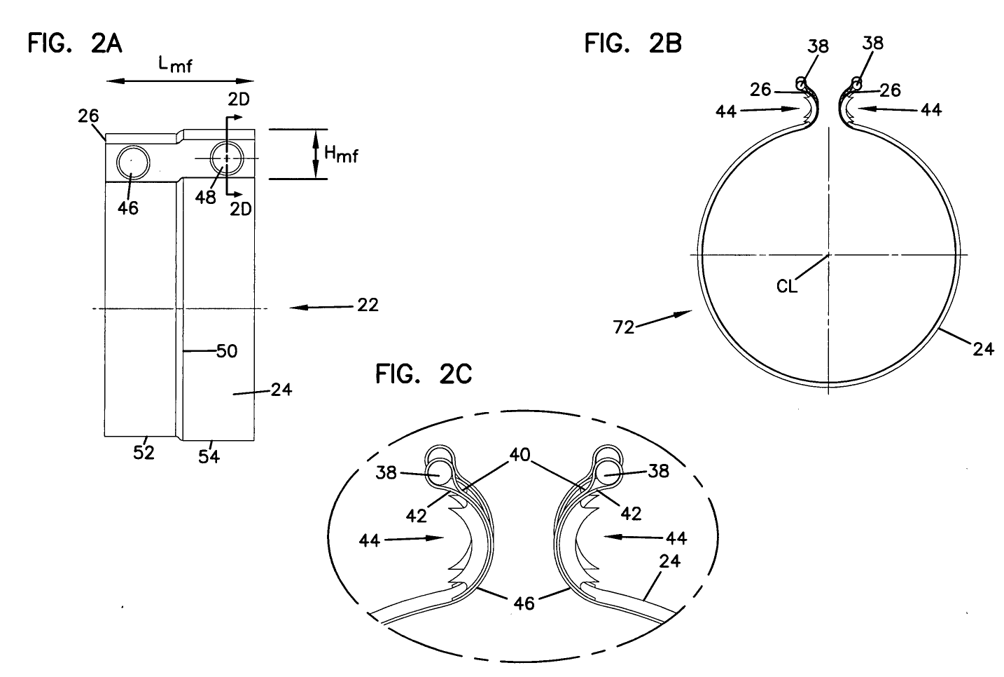

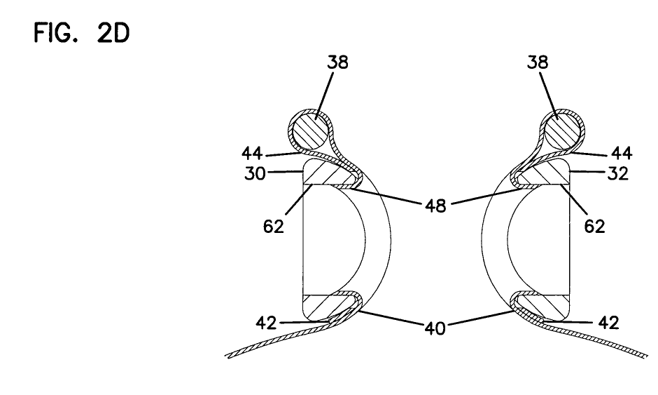

Referring to FIGS. 2A-2D, the band 22 of the clamp 20 is shown. The band 22 is preferably made of a relatively thin, ductile metal material such as stainless steel or aluminized steel. It will be appreciated that the diameter, the wall thickness and the axial length of the band 22 will vary based on intended use. In one non-limiting embodiment of the present invention, the band 22 is made of stainless steel and has a wall thickness in the range of 0.013-0.023 inch.

Referring to FIG. 2B, the main body 24 of the band 22 is pre-formed into a generally cylindrical shape, and the bolt mounting flanges 26 are located at opposite ends of the main body 24. The bolt mounting flanges 26 are formed by doubled over portions of the band 22. For example, as best shown in FIG. 2C, each of the bolt mounting flanges 26 is formed by bending the band 22 around one of the retaining bars 38 to form a doubled over portion including an inner wall 40 and an outer wall 42. The bolt mounting flanges 26 are then bent (e.g., through a die forming process) to define outwardly facing concave pockets 44 sized to receive the outer reinforcing bars 30 and 32.

Referring now to FIG. 2A, the bolt mounting flanges 26 each include a length L_{mf} and a height H_{mf}. The length L_{mf} corresponds to the axial length of the clamp 20 and the height H_{mf} extends generally in a radial direction with respect to a center line CL of the clamp 20. Two sets of bolt openings 46 and 48 are defined through the bolt mounting flanges 26. The bolt openings 46 and 48 are preferably sized to receive the bolts 34 with a conventional clearance fit. The bolt openings 46 and 48 are spaced apart along the length L_{mf} of each bolt mounting flange 26 and are staggered in a direction corresponding to the height H_{mf} of each bolt mounting flange 26 (see FIG. 2A).

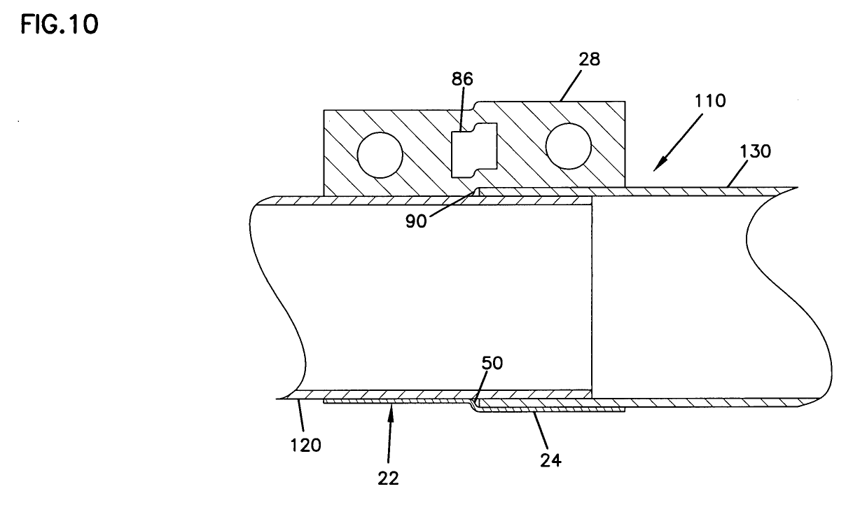

Referring still to FIG. 2A, a step 50 is shown extending about the circumference of the main body 24 of the band 22. The step 50 is located generally at a mid point of the axial length of the clamp 20, and has a height dimensioned to correspond generally to the wall thickness of a pipe 130 or other conduit over which the clamp 20 is intended to be mounted (see FIG. 10). The amount of stagger provided between the bolt openings 46 and 48 corresponds generally to the height of the step 50. Preferably, the bolt openings 46 and 48 are centered generally along the height H_{mf} of each bolt mounting flange 26. It will be appreciated that the staggering of the bolt openings 46 and 48 is preferably provided in a radial direction relative to the center line CL of the clamp 20.

The step 50 preferably extends about the entire circumference of the main body 24 of the band 22. The step 50 provides a diameter transition between a smaller diameter portion 52 and a larger diameter portion 54 of the band 22.

b. Outer Reinforcing Bar Description

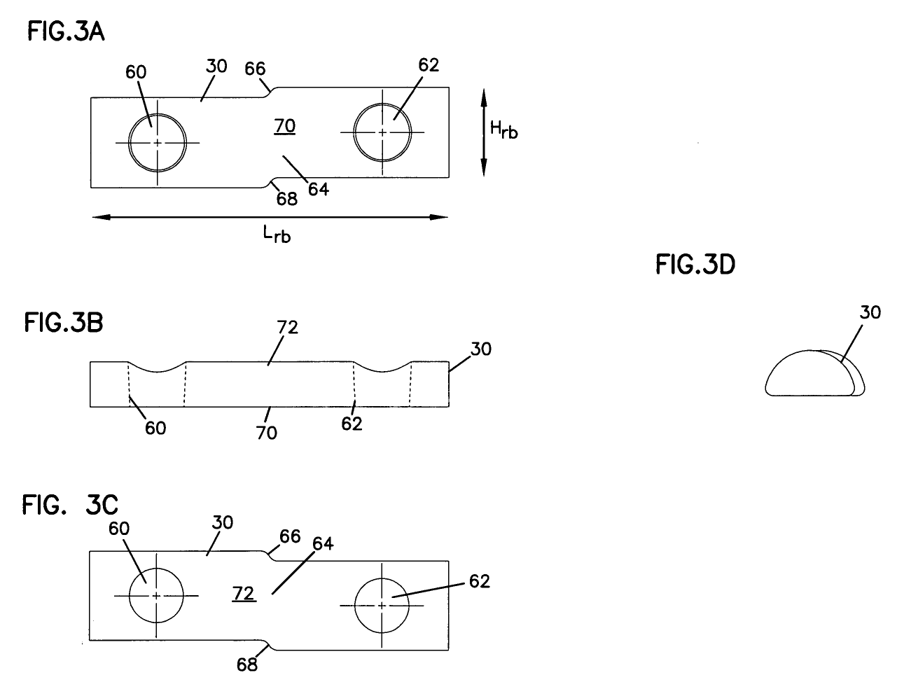

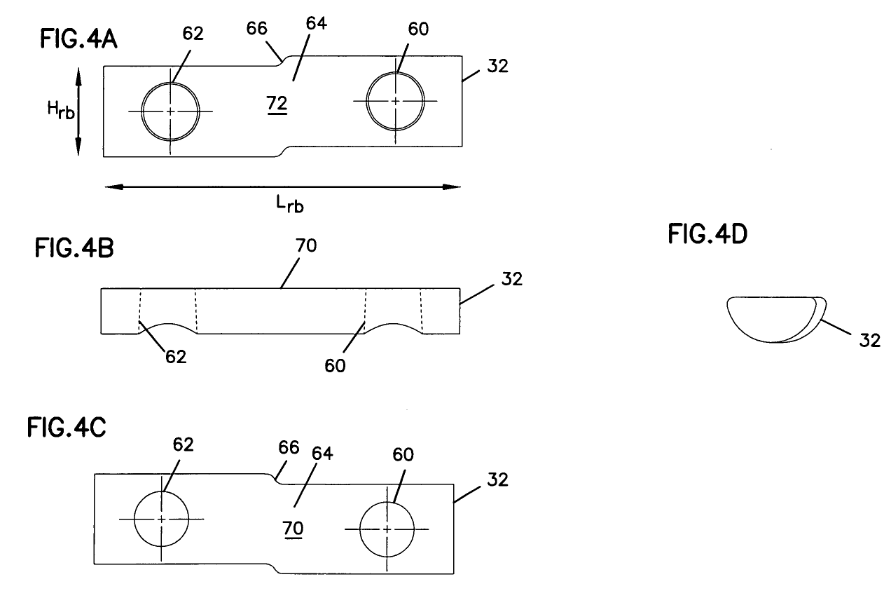

FIGS. 3A-3B and 4A-4D respectively illustrate the outer reinforcing bars 30 and 32 of the clamp 20. Each of the outer reinforcing bars 30 and 32 includes a height H_{rb} and a length L_{rb}. Each of the outer reinforcing bars 30 and 32 also defines two bolt openings 60 and 62 adapted to respectively align with the sets of bolt openings 46 and 48 defined by the bolt mounting flanges 26 of the clamp 20. The bolt openings 60 and 62 are staggered in a direction corresponding to the height H_{rb}. The staggering is provided by a height offset 64 positioned between the bolt openings 60 and 62. The height offset 64 includes first and second steps 66 and 68 separated by the height H_{rb} of the outer reinforcing bars 30 and 32. Each of the outer reinforcing bars 30 and 32 also includes a generally flat surface 70 adapted to face outwardly from the clamp 20, and a convex surface 72 having a curvature and size selected to nest within and complement the curvature of the concave pockets 44 of the bolt mounting flanges 26. The height offset 64 is preferably positioned such that when the outer reinforcing bars 30 and 32 are mounted on the clamp 20, the height offset 64 aligns generally with the step 50 formed in the band 22.

The outer reinforcing bars 30 and 32 can be manufactured from a length of half-round steel or aluminum extrusions having a radius selected to correspond to the curvature of the concave pockets 44. To manufacture the outer reinforcing bars 30 and 32, the bolt openings 60 and 62 can be punched through the half-round steel with a conventional punch press. Before or after punching the holes 60 and 62, the offset 64 can be provided through the use of a press (i.e., a die forming process). The outer reinforcing bars 30 and 32 can be sheared to length either before or after the punching and pressing steps. The holes 60 and 62 have diameters that taper. For example, as shown at FIG. 3B, the diameters gradually reduce as the holes 60, 62 extend from surface 72 to surface 70.

c. Retaining Bar Description

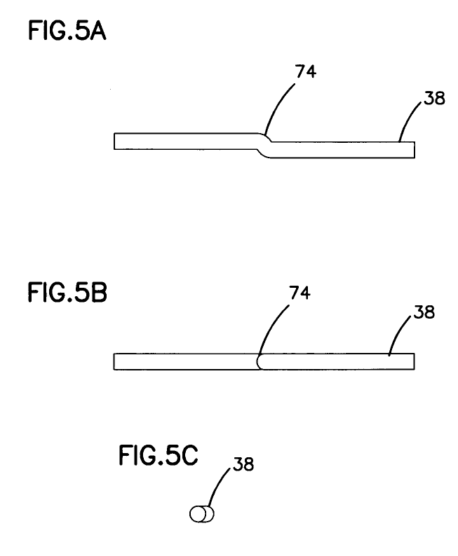

FIGS. 5A-5C show one of the retaining bars 38 of the clamp 20. The depicted retaining bar 38 includes an intermediate step or offset 74 adapted to align with the step 50 of the band 22 when the clamp 20 is assembled. In one non-limiting embodiment, the retaining bar 38 is made from a length of steel or aluminum wire that has been cut to size and stamped or pressed to form the offset 74.

d. Sealing Bar Description

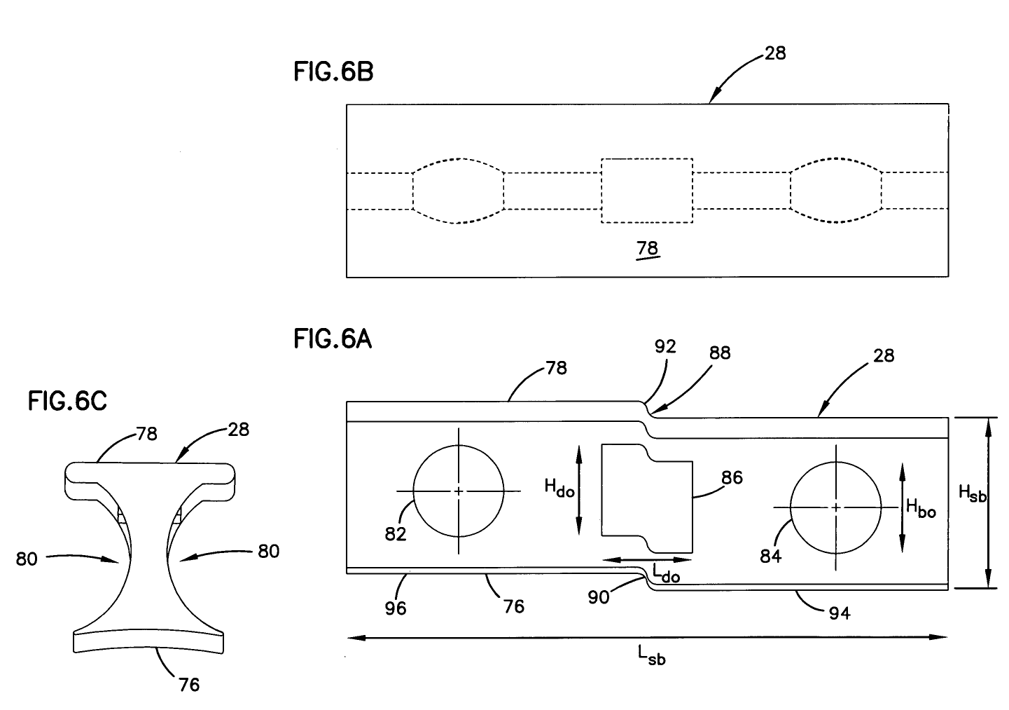

FIGS. 6A-6C illustrate the sealing bar 28 in isolation from the clamp 20. The sealing bar 28 includes a length L_{sb} and a height H_{sb}. The sealing bar 28 includes a sealing surface 76 and a reaction surface 78. The sealing surface 76 and the reaction surface 78 are separated by the height H_{sb} by the sealing bar 28. When the clamp 20 is assembled, the sealing bar 28 is arranged such that the height H_{sb} extends in a radial direction from the center line CL of the clamp 20. As so positioned, the sealing surface 76 blends generally with the curvature of the main body 24 of the band 22, and the reaction surface 78 is positioned immediately below the retaining bars 38. The sealing bar 28 defines outwardly facing concave pockets 80 (best shown in FIG. 6C) that receive the concave pockets 44 of the band 22 when the clamp 20 is assembled. The concave pockets 44 of the band 22 preferably nest within the concave pockets 80 of the sealing bar 28 (see FIG. 1A).

Referring to FIG. 6A, the sealing bar 28 defines bolt openings 82 and 84 adapted to respectively align with the bolt openings 46 and 48 of the bolt mounting flanges 26 when the clamp 20 is assembled. A deformation opening 86 is located between the bolt openings 82 and 84. The deformation opening 86 has a length L_{do} and a height H_{do}. In a preferred embodiment, the ratio of the height H_{do} to the length L_{do} is in the range of 0.75 to 1.25. In a more preferred embodiment, the ratio of the height H_{do} to the length L_{do} is in the range of 0.9 to 1.1. In the most preferred embodiment, the ratio of the height H_{do} to the length L_{do} is about 1 to 1.

Referring still to FIG. 6A, the bolt openings and 82 and 84 each have a height H_{do}. Preferably, the H_{do} of the deformation opening 86 is at least 50% of the height H_{do} of the bolt openings 82 and 84. More preferably, the height H_{do} of the deformation opening 86 is at least 75% as tall as the height H_{do} of the bolt openings 82 and 84. Even more preferably, the height H_{do} of the deformation opening 86 is at least 90% as tall as the height H_{do} of the bolt openings 82 and 84. Most preferably, the height H_{do} of the deformation opening 86 is about the same as the height H_{do} of the bolt openings 82 and 84.

Referring still to FIG. 6A, the sealing bar 28 has an offset portion 88 located between the bolt openings 82 and 84. The offset portion 88 includes a first step 90 located at the sealing surface 76 and a second step 92 located at the reaction surface 78. The first and second steps 90 and 92 are adapted to align with the step 50 of the band 22. It will be appreciated that the first step 90 preferably is dimensioned to correspond generally to the height of the step 50 of the band 22. Thus, the sealing surface 76 includes a first portion 94 adapted to align generally with the smaller diameter portion 52 of the band 22 and a second portion 96 adapted to align with the larger diameter portion 54 of the band 22. The sealing surface 76 provides a smooth transition across the gap provided between the bolt mounting flanges 26 of the clamp 20.

The sealing bar 28 is preferably made of an extruded material such as extruded aluminum. To manufacture the bar, the extruded bar is punched to provide the bolt openings 82 and 84 and the deformation opening 86. The offset portion 86 is then provided through the use of a punch press (i.e., a forming die). Prior to forming the offset portion 88, the deformation opening 86 is preferably square or generally rectangular. The deformation opening 86 facilitates forming the offset portion 88 through the use of the punch press by providing a “weaker” location in the bar 28. After the offset portion 88 has been provided, the deformation 86 has an intermediate step that corresponds to the offset portion 88. The extrusion bar 28 can be cut to length either before or after the bar has been punched and stepped.

While it is preferred for the bar 28 to be extruded, other manufacturing techniques (e.g., casting) could also be used.

Additional embodiments of sealing bars are illustrated in FIGS. 31A, 31B, 32A and 32B, the details of which are described below.

e. Description of Nut Bar and Fastener

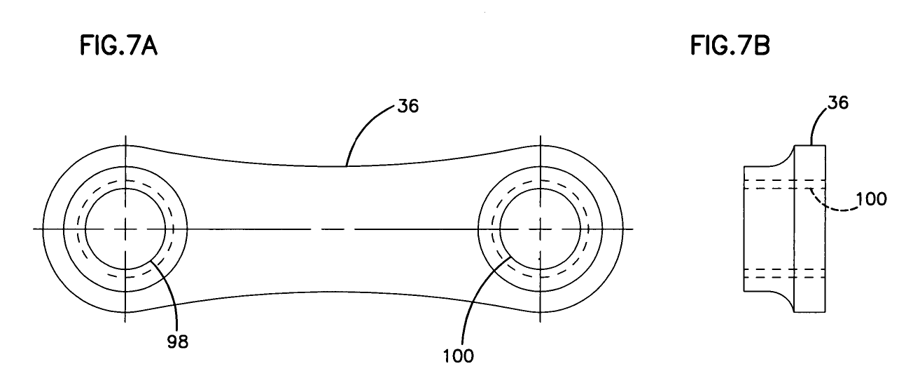

FIGS. 7A and 7B illustrate the nut bar 36 of the clamp 20. The nut bar can be made of a material such as aluminum, steel or aluminized steel. Internally threaded openings 98 and 100 are preferably extruded and then tapped through the nut bar 36. The openings 98 and 100 are sized to threadingly receive the bolts 34 of the clamp 20. The openings 98 and 100 are positioned to respectively align with the bolt openings 46 and 48 of the band 22 when the clamp 20 is assembled.

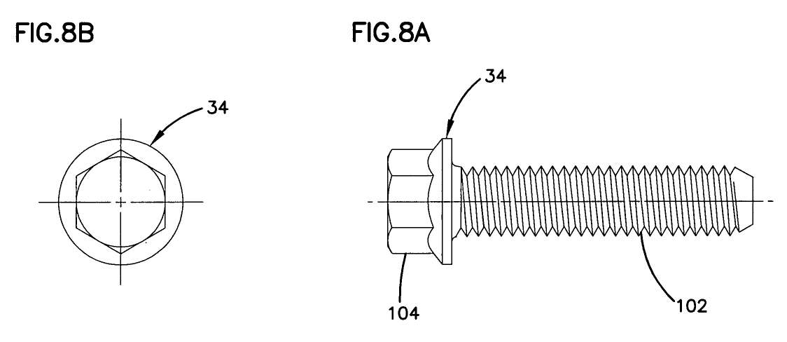

FIGS. 8A and B show one of the bolts 34 of the clamp 20. The depicted bolt 34 has a threaded end 102 sized to be threaded within the nut bar 36. A head 104 is located at one end of the bolt 34. When the clamp 20 is assembled, the head 104 butts against the outer reinforcing bar 32 and the nut bar 36 abuts against the outer reinforcing bar 30.

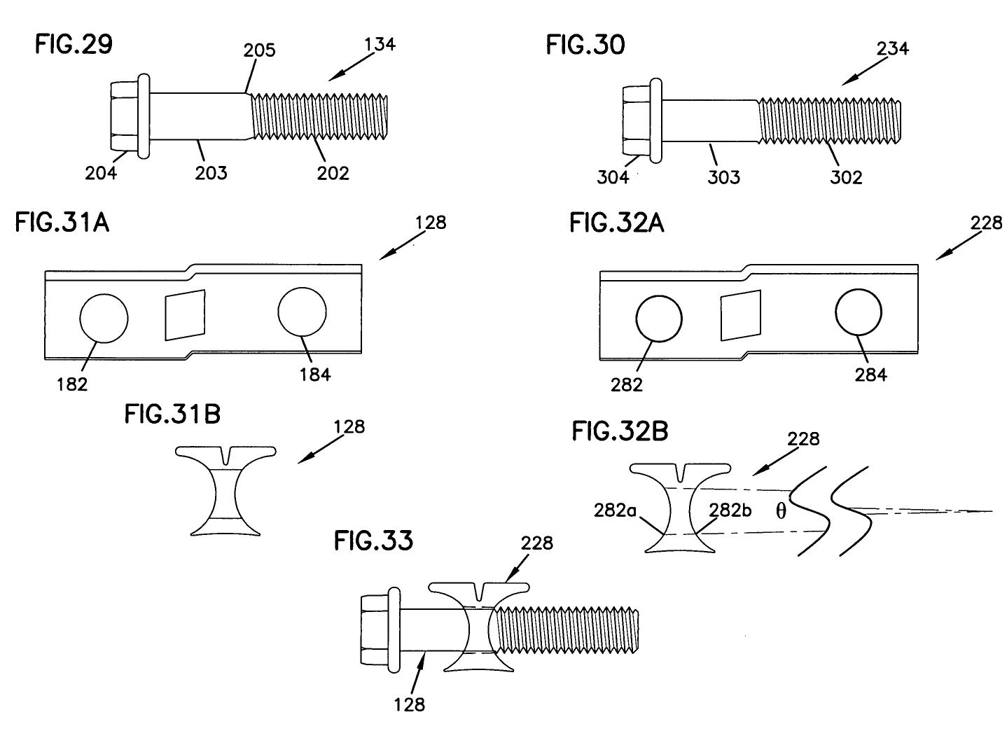

FIGS. 29 and 30 show alternate embodiments of bolts that can be used with clamp 20 and sealing bars for use with these bolts.

Bolt 134 of FIG. 29 has a threaded end 202 configured to be threaded within nut bar 36. Bolt 134 includes a head 204 located at one end of bolt 134 opposite threaded end 202. Positioned between head 204 and threaded end 202 is unthreaded shank 203. Bolt 134, with the exception of head 204, has a generally constant diameter; that is, threaded end 202 has an outer thread diameter similar to unthreaded shank 203.

Bolt 134 is configured for use with sealing bar 128, illustrated in FIGS. 31A and 31B, having openings 182, 184 each sized for receiving a separate bolt 134 therethrough. Openings 182, 184 can have a diameter greater than both threaded end 202 and unthreaded shank 203. In one particular embodiment, threaded end 202 of bolt 134 has a diameter of 0.435 inch, unthreaded shank 203 has a diameter of 0.438 inch, and openings 182, 184 of sealing bar 128 have a diameter of 0.453 inch. It will be appreciated that the bolts 134 and sealing bar 128 can be used in the same manner as bolts 34 and sealing bar 28, and can be used with any of the clamp embodiments disclosed herein.

In other embodiments, the bolt 134 can be used with sealing bars having bolt holes that are smaller than the outer thread diameter of the bolt 134. For example, the bolt 134 can be used with a sealing bar such as sealing bar 228 shown in FIGS. 32A and 32B. The sealing bar 228 has bolt holes 282, 284 that are tapered so as to define a major diameter at one side of the bar 228 (e.g., see 282a for hole 282) and a minor diameter at the other side of the bar 228 (e.g., see 282b for hole 282). In certain embodiments, the minor bolt hole diameters of the holes 282, 284 are selected such that the bolts 234 will roll form loose threads into the sealing bar 228 within the openings 282, 284. The bar 228 is preferably made of a relatively soft metal such as aluminum. Preferably, the bolts 134 are threaded into the openings 282, 284 until threads have passed through the openings 282, 284 and sealing bar 228 is retained/captured at transition portion 205 (i.e., the transition between the shank and threads) by the threads to reduce the number of loose parts. The holes 282, 284 and the diameter of the shank are preferably relatively sized such that the shank 203 can be hand-turned within the openings 282, 284, or turned with slight assistance from a wrench or other tool. In certain embodiments, the outer diameter of the threads is at least 0.004 inches greater than the minor diameter of the holes 282, 284. In other embodiments, the outer diameter of the threads is at least 0.005 inches greater than the minor diameter of the holes 282, 284. In other embodiments, the outer diameter of the threads is at least 0.006 inches greater than the minor diameter of the holes 282, 284. In other embodiments, the outer diameter of the threads is at least 0.007 inches greater than the minor diameter of the holes 282, 284. In other embodiments, the outer diameter of the threads is in the range of 0.004-0.011 inches larger than the minor diameter of the holes 282, 284. In still other embodiments, the outer thread diameter of the bolts is in the range of 0.004-0.009 inches larger than the minor diameter of the holes 282, 284. In still other embodiments, the outer thread diameter of the bolts is in the range of 0.004-0.007 larger than the minor diameter of the holes 282, 284. In one embodiment, the bolts 134 have an outer thread diameter of about 0.368 inches, and the bolt holes 282, 284 have minor diameters ranging from 0.361 to 0.364 inches and major diameters ranging from 0.400 to 0.403 inches.

Referring to FIG. 30, bolt 234 has a threaded end 302 configured to be threaded within nut bar 36. Bolt 234 includes a head 304 located at one end of bolt 234 opposite threaded end 302. Positioned between head 304 and threaded end 302 is unthreaded shank 303. The outer thread diameter of threaded end 302 is preferably greater than the diameter of unthreaded shank 303. In one embodiment, the outer thread diameter of the threaded end 302 is greater than the diameter of the unthreaded shank 303 by at least 0.02 inch, preferably by at least 0.03 inch, and more preferably by at least 0.045 inch. In another embodiment, the diameter of threaded end 302 is greater than the diameter of unthreaded shank 303, by at least 5 percent, preferably by at least 7 percent, and more preferably by at least 10 percent; alternately, the diameter of unthreaded shank 303 is 75-98 percent of the outer thread diameter of threaded end 302, preferably 80-95 percent, and more preferably, about 90 percent. In other embodiments, the diameter difference between the outer thread diameter and the diameter of the shank can be less than 0.02 inch.

Bolt 234 is configured for use with sealing bar 228, illustrated in FIGS. 32A and 32B, having openings 282 and 284 for each receiving a separate bolt 234 therethrough. As indicated above, the sealing bar 228 is preferably made of a relatively soft metal such as aluminum. Openings 282, 284 are tapered through the thickness of sealing bar 228. In certain embodiments, the openings can define a cone angle θ greater than 3 degrees or greater than 4 degrees or greater than 5 degrees or greater than 6 degrees or greater than 7 degrees or at least 8 degrees.

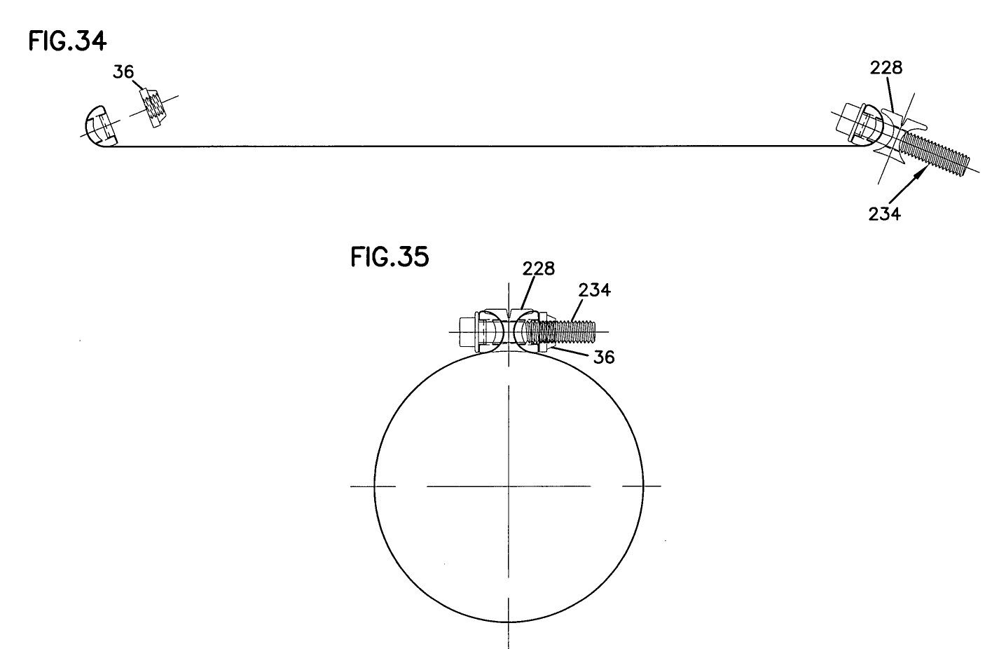

The configuration of openings 282, 284 preferably provides a slight interference fit with the threads at threaded end 302 (e.g., similar to that described with respect to the threaded end 202 of bolt 134), but provides an easy slip fit with the unthreaded shank 303; see FIG. 33, where bolt 234 is illustrated within sealing bar 228. In use, the bolts 234 will roll form or cut loose threads into the sealing bar 228 within the openings 282, 284 such that the bar 228 is retained on the bolts 234 (as shown in FIG. 34) to reduce the number of loose parts in the assembly.

Referring to FIG. 32B, as described above, opening 282 has a first diameter at side 282a of sealing bar 228 and a second diameter at side 282b of sealing bar 228. In certain embodiments, the diameter side 282a is greater than the diameter at side 282b by at least 0.02 inch, or by at least 0.03 inch, or by at least 0.04 inch. In other embodiments, the diameter at side 282a is greater than the diameter at side 282b, by at least 4 percent, or by at least 5 percent, or by at least 10 percent. The tapered openings 282, 284 are advantageous for a punch press manufacturing operation and provide a lead-in for the assembly operation.

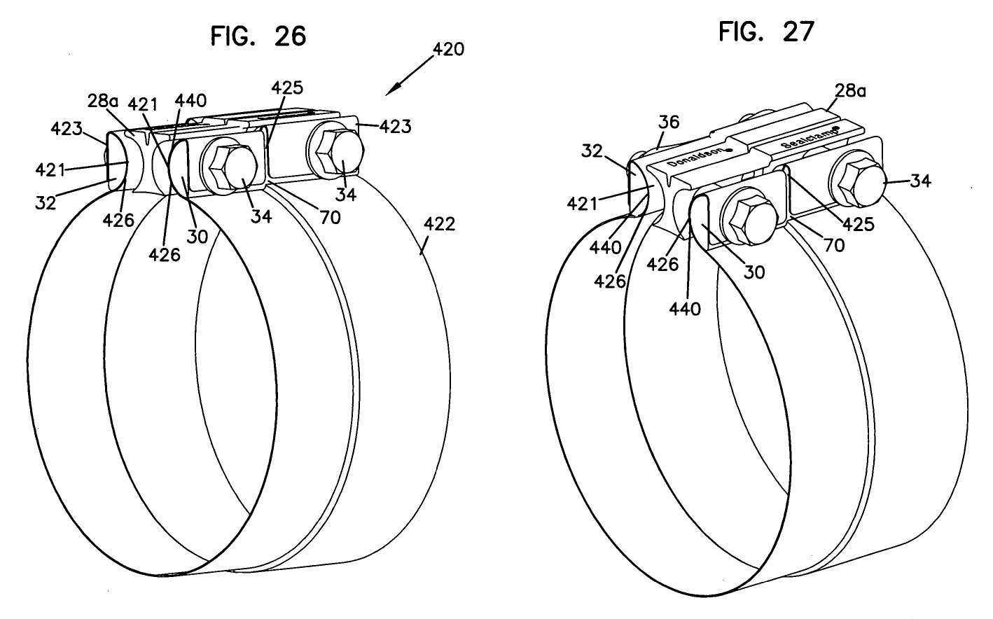

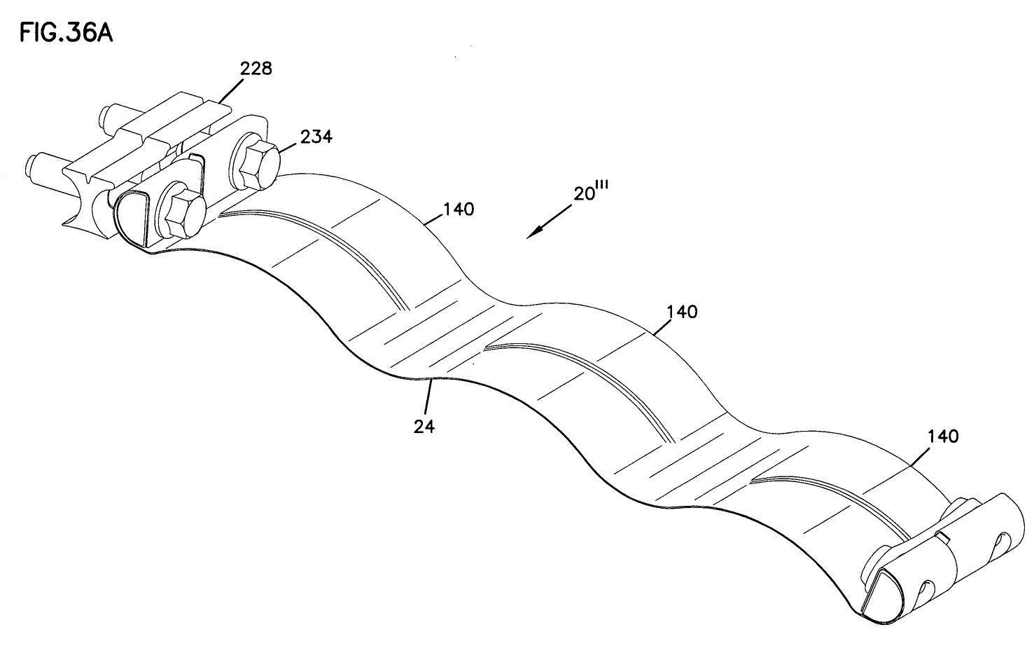

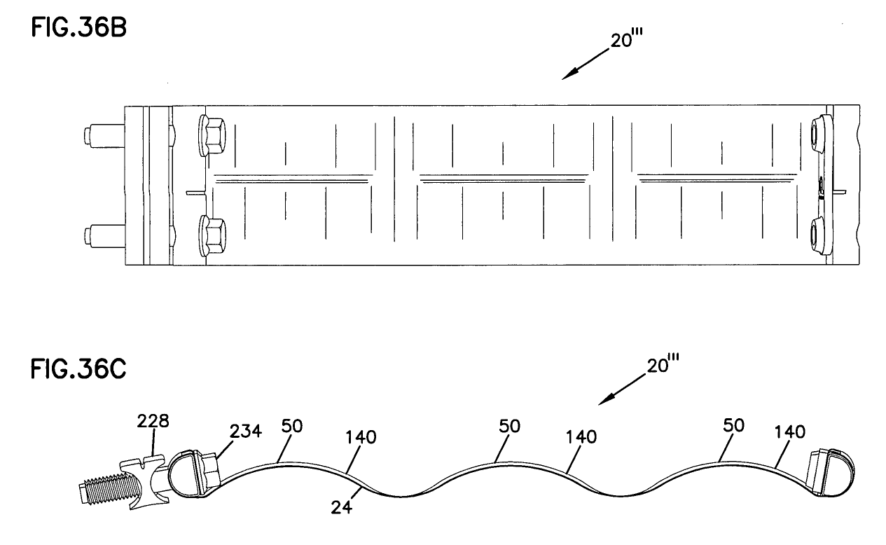

The bolts 234 and sealing bar 228 are illustrated incorporated into one clamp in FIGS. 34 and 35, and another clamp in FIGS. 36A-36C. The clamp of FIGS. 34 and 35 has a flat configuration prior to use, while the clamp of FIGS. 36A-36C is provided with factory manufacture bends or humps to facilitate installation. Both the clamp of FIGS. 34 and 35, and the clamp of FIGS. 36A-36C have a band that wraps around and is punched into its corresponding reinforcing bars in the same type of configuration described with respect to the embodiment of FIGS. 26-28A. In the shown embodiment, the only separate component of the clamp is the nut bar 36 since the threads of the bolts 234 prevent the sealing bar 228 from falling off the bolts 234 prior to use. In certain embodiments, a loose slip fit is provided between the sealing bar 228 and the non-threaded shanks of the bolts 234.

In one particular embodiment, threaded end 302 of bolt 234 has a diameter of 0.435 inch and unthreaded shank 303 has a diameter of 0.388 inch, and openings 282, 284 of sealing bar 228 have a diameter of 0.435 inch at a first side and 0.421 at a second side of bar 228. In another embodiment, the threaded end 302 has an outer thread diameter of about 0.368, and the openings 282, 284 have minor diameters ranging from 0.361 to 0.364 inch and the major diameters ranging from 0.400 to 0.403 inch.

III. Manufacture of Clamp

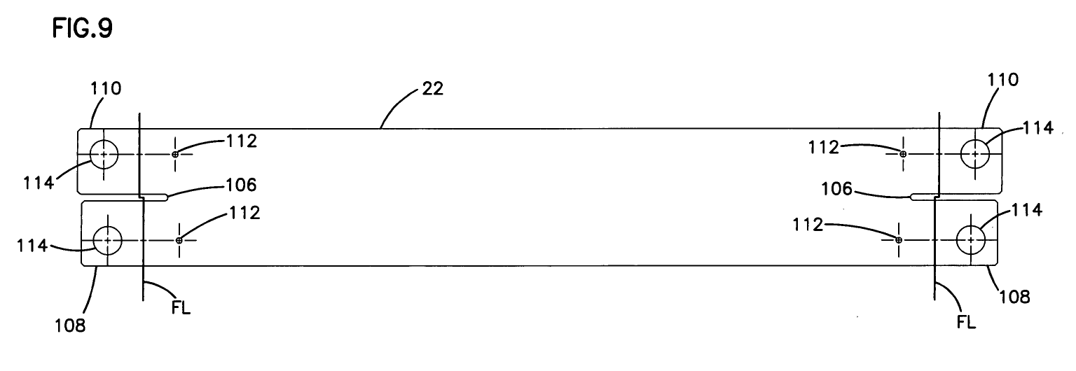

To manufacture the clamp 20, a strip of relatively thin (e.g., approximately 0.018 inch) material is provided. Preferred materials include stainless steel or aluminized steel. To initiate the manufacturing process, slots 106 are preferably punched into the ends of the strip as shown in FIG. 9. The slots 106 define first and second ears 108 and 110 located at each end of the band 22. The first ears 108 are shorter than the second ears 110. After punching the slots 106, relatively small extrusion holes 112 and large precursor bolt holes 114 are punched through the band 22. The holes 112 and 114 corresponding to the first ear 108 are staggered relative to the holes 112 and 114 defined by their corresponding ear 110.

After punching the holes 112 and 114, the ends of the band 22 are partially bent or “doubled over” at fold lines FL located between the holes 114 and the holes 112. After the ends of the band 22 have been partially bent, the pre-stepped retaining bars 38 are positioned along the fold lines FL and the fold is completed (e.g., by using a press). After folding, the openings 114 co-axially align with the openings 112. The slots 106 assist in aligning the openings 114 with the openings 112 during the folding process. It will be appreciated that the folded over portions at the ends of the band 22 form the bolt mounting flange 26 of the clamp 20.

After the ends of the band 22 have been folded to form the bolt mounting flanges 26, the flanges 26 are bent with a forming die to form the concave pockets 44. The outer reinforcing bars 30 and 32 are then placed within the pockets 44 and the holes 112 are punched outwardly through the openings 114 with a punch having a size corresponding to a clearance opening for the bolts 34, 134, 234. During the punching process, material corresponding to the inner wall 40 of each mounting flange 26 is extruded through the openings 114 and into the openings 60 and 62 of the outer reinforcing bars 30 and 32 (see FIG. 2D). By extruding portions of the inner wall 40 into the bolt opening 60 and 62, the outer reinforcing bars 30 and 32 are fastened or fixed to the bolt mounting flange 26.

After the outer reinforcing bars 30 and 32 have been connected to the band 22, the band 22 is wrapped around a cylindrical mandrel. A spacer piece having a size corresponding to the sealing bar 28 is mounted between the bolt mounting flanges 26 and a clamp is used to tighten the band 22 about the mandrel. The mandrel preferably has a split collet arrangement that engages a portion of the band 22 that will later be the enlarged diameter portion 54 of the band 22. By expanding the split collet arrangement, the portion of the band 22 corresponding to the larger diameter portion 54 is expanded outwardly. As the collet expands, the enlarged diameter portion 54 deforms while the reduced diameter portion 52 maintains about the same diameter. The step 50 is formed at the edge of the split collet and provides a transition from the larger diameter portion 54 to the smaller diameter portion 52.

Once the step 50 has been formed, the band 22 is removed from a mandrel and the sealing bar 28 having the preformed offset portion 88 is inserted between these bolt mounting flanges 26. The bolts 34, 134, 234 are then inserted through the openings 60 and 62 of the outer reinforcing bars 30 and 32, the openings 46 and 48 of the mounting flanges 26 and the openings 82 and 84 of the sealing bar 28. Once so inserted, the bolts 34, 134, 234 are threaded within the nut bar 36 located adjacent to the outer reinforcing bar 32. In this manner, the bolts 34, 134, 234 fasten the bolt mounting flanges 26 together. As so fastened, the retaining bars 36 are positioned above the outer reinforcing bars 30 and 32 and the reaction surface 78 of the sealing bar 28.

When the clamp 20 is tightened about a lap joint, the retaining bars 38 are drawn down against the reinforcing bars 30 and 32 and the reaction surface 78 of the sealing bar 28. The retaining bars 38 are too large to fit between the relatively narrow gaps formed between the reinforcing bars 30 and 32 and the reaction surface 78 of the sealing bar 28. Thus, the retaining bars 38 prevent the bolt mounting flanges 26 from tearing at the bolt openings 46, 48 and slipping between the sealing bar 28 and the outer reinforcing bars 30 and 32.

IV. Use of Clamp

FIG. 10 shows the clamp 20 being used to seal a lap joint 110. As shown in FIG. 10, the first step 90 of the sealing bar 28 conforms to the step provided between two conduits such as inner pipe 120 and outer pipe 130. Similarly, the step 50 provided in the band 22 also conforms to the step between inner pipe 120 and outer pipe 130. The deformation opening 86 allows the sealing bar 28 to deform more or less greatly at the first step 90 if the step between the lap joint pipes 120 and 130 is different than the pre-formed step provided in the sealing bar 28.

It will be appreciated that the initial step 90 provided in the sealing bar 28 is a factory-manufactured step. The term “factory manufactured step” means that the step was provided prior to actually using the clamp 20 at a lap joint. A factory-manufactured step is preferably made to relatively precise manufacturing tolerances.

V. Other Embodiments

In the previously discussed embodiment, the step 50 is preferably defined along substantially the entire main body 24 of the band 22. The step 50 and the step 90 of the sealing bar 28 cooperate to provide substantially a 360 degree seal about a lap joint.

It will be appreciated that in alternative embodiments the band 22 may not include a pre-formed step such as step 50. Instead, due to the inherent deformability of the material forming the band 22, the step 50 can be provided through deformation in the field. Further, in some embodiments, it may be desirable to provide a pre-formed step 50 along only a portion of the main body 24. Moreover, to promote ease of shipping, it may be desirable to ship the clamp 20 while the main body 24 is in a generally flat configuration. With this type of arrangement, an end user would bend the clamp into the generally cylindrical configuration as the clamp is being used to seal a lap joint.

a. Clamp Having Band Without Pre-formed Curve or Pre-formed Step

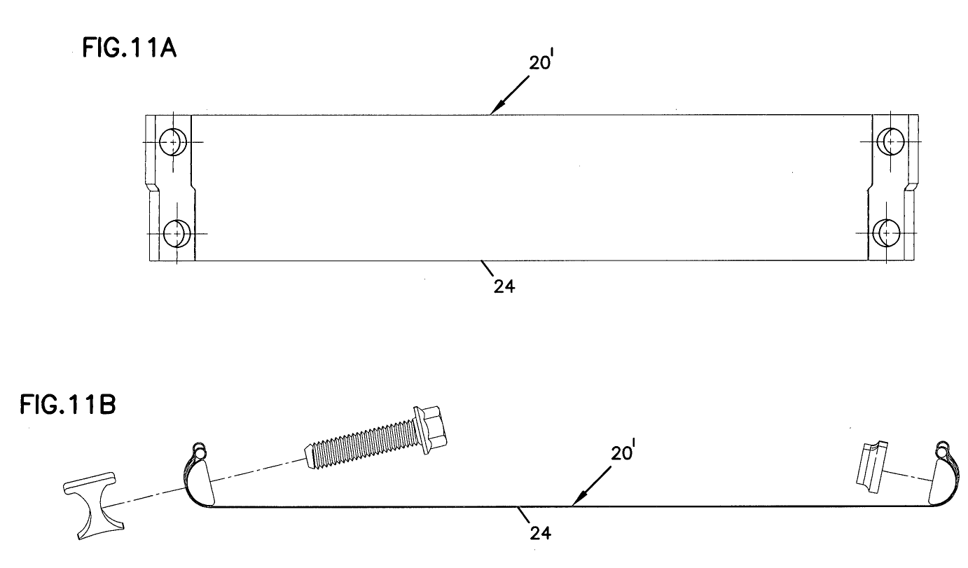

FIGS. 11A and 11B show an exemplary clamp 20′ that does not have a pre-formed step 50 and is preferably shipped with the main body 24 of the band 22 in a generally flat configuration. The clamp 20′ preferably includes the same fastening hardware as the clamp 20 of FIGS. 1A-1C. Another clamp lacking a pre-formed step in the band is shown in FIGS. 34 and 35.

b. Clamp Having Band With Pre-formed “S” Shape

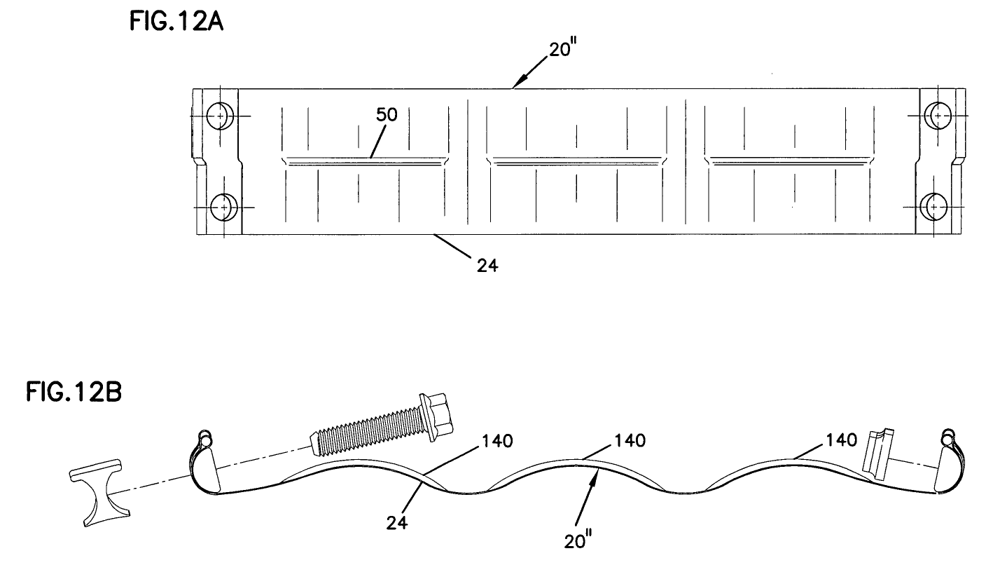

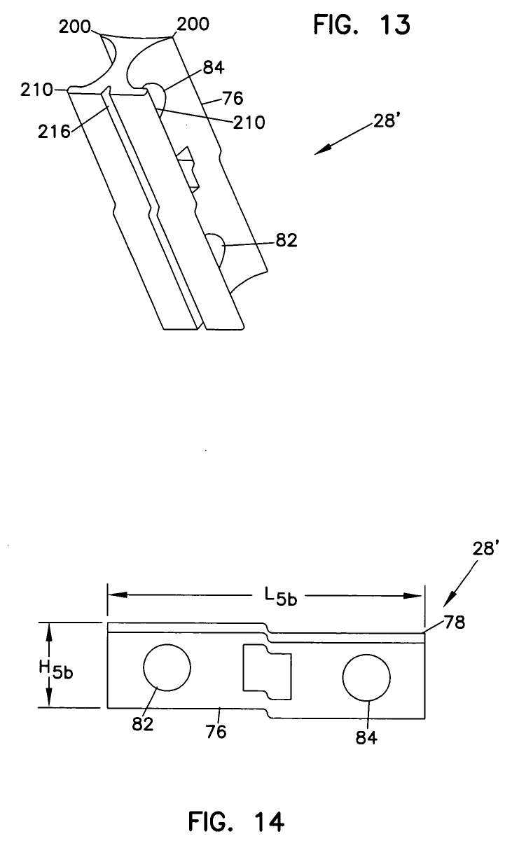

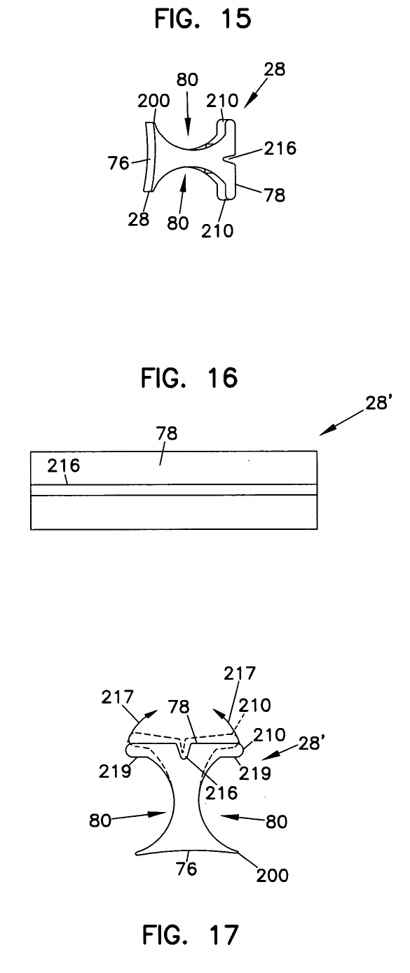

FIGS. 12A and 12B show a clamp 20″ that is another embodiment of the present invention. The main body 24 of the band has an S-shaped curvature similar to the curvatures shown in U.S. Pat. No. 4,790,574, that is hereby incorporated by reference. The S-shaped curvature defines three curved humps 140. A pre-form step 50 is formed along only a portion of the length of the main body 24. The humps 140 assist an end user in wrapping the clamp 20″ about a lap joint. The clamp 20″ preferably includes the same fastening hardware as the clamp 20 of FIGS. 1A-1C.

FIGS. 36A, 36B and 36C show a clamp 20′″ that is yet another embodiment of the present invention. The main body 24 of the band has three curved humps 140. Pre-formed steps 50 are pressed/formed into the main body 24 at the humps 140. The humps 140 assist an end user in wrapping the clamp 20″ about a lap joint. The clamp 20′″ preferably includes the fastening hardware of FIG. 30 (bolt 234), and FIGS. 32A and 32B (sealing bar 228). In other embodiments, the pre-formed steps can be eliminated from the band.

c. Modified Sealing Bar

FIGS. 13-17 illustrate a sealing bar 28′ that is an embodiment of the present invention. The sealing bar 28′ is adapted for use with any of the clamps 20, 20′ or 20″ previously described herein. It will also be appreciated that the sealing bar 28′ could also be used with clamps other than those specifically described herein such as clamps having a configuration similar to the clamps disclosed in U.S. Pat. No. 4,312,526 to Cassel.

The sealing bar 28′ has many of the same structural features as the sealing bar 28 that was previously described. To avoid repetition, components previously described with respect to the sealing bar 28 will be assigned the same reference numeral.

The sealing bar 28′ will be described with reference to clamp 20. However, as indicated above, the sealing bar 28′ is also applicable to any number of different types of clamps.

The sealing bar 28′ includes length L_{sb} and height H_{sb}. The sealing bar 28′ also includes sealing side 76 and reaction side 78 separated by the height H_{sb}. When the sealing bar 28′ is assembled with the clamp 20, the sealing bar 28′ is arranged such that the height H_{sb} extends in a radial direction from the center line of the clamp 20. As so positioned, the sealing side 76 blends generally with the curvature of the main body 24 of the flange 22, and the reaction side 78 is positioned immediately below the retaining bars 38. The sealing bar 28′ defines outwardly facing concave pockets 80 that receive the concave pockets 44 of the flanges 26 when the clamp 20 is assembled. The concave pockets 44 of the flanges 26 preferably nest within the concave pockets 80 of the sealing bar 28′. The sealing bar 28′ further defines bolt openings 82 and 84 adapted to respectively align with the bolt openings 46 and 48 of the bolt mounting flanges 26 when the clamp 20 is assembled.

Each of the concave pockets 80 is defined by a sealing leg 200 and an opposing reaction leg 210. While the pockets 80 have been described as concave, it will be appreciated that other shaped pockets could also be used. For example, pockets formed by a plurality of linear segments could also be used.

To enhance deformation of the sealing bar 28′, the reaction side 78 includes a relief structure for facilitating deformation of the reaction legs 210 as the clamp 20 is tightened. Preferably, the relief structure is configured to allow the reaction legs 210 to deform slightly toward one another as the clamp 20 is tightened (see arrows 212 of FIG. 17 which illustrate the direction of deformation). The relief structure allows the reaction legs 210 to deform without requiring excessive clamping pressure. The deformation of the reaction legs 210 allows the sealing side 76 to better seat on the conduits being clamped such that a better seal is provided. As is apparent from FIG. 17, the reaction legs 210 include flats 219 that facilitate deformation of the legs 210. When the bolts 34, 134, 234 are tightened to close the clamp, convex surfaces 72 of reinforcing bars 30, 32 as well as the concave pockets 40 of the flanges 26 are pressed within the pockets 80 of the sealing bar 28′. To accommodate the reinforcing bars 30, 32 and the pockets 40 within the sealing bar pockets 80, the flats 219 deflect outwardly along arrows 217.

As best shown in FIGS. 13, 15 and 16, the depicted relief in the sealing side 76 of the sealing bar 28′ includes a notch 216. The notch 216 is shown having a generally triangular transverse cross-section. The notch 216 is positioned in alignment with a center line of the sealing bar 28′ and extends along the length of the sealing bar 28′. As shown in FIG. 17, the notch 216 provides a relief area for facilitating deformation of the reaction legs 210. The legs 210 deflect in the direction of arrows 217. When the reaction legs 210 deform, the notch 216 at least partially closes (see phantom line in FIG. 17).

While the relief notch 216 has been shown having a generally triangular or V-shaped transverse cross-section, it will be appreciated that other cross-sections such as rectangular, rounded, U-shaped, semi-circular or other shapes could also be used. The closure of the notch during tightening can be either partial or complete. Also, the degree of closure of the notch can be used as an installation indicator to indicate proper bolt tightening.

d. Clamp With Structure for Retaining Reinforcing Bars in Flange Pockets

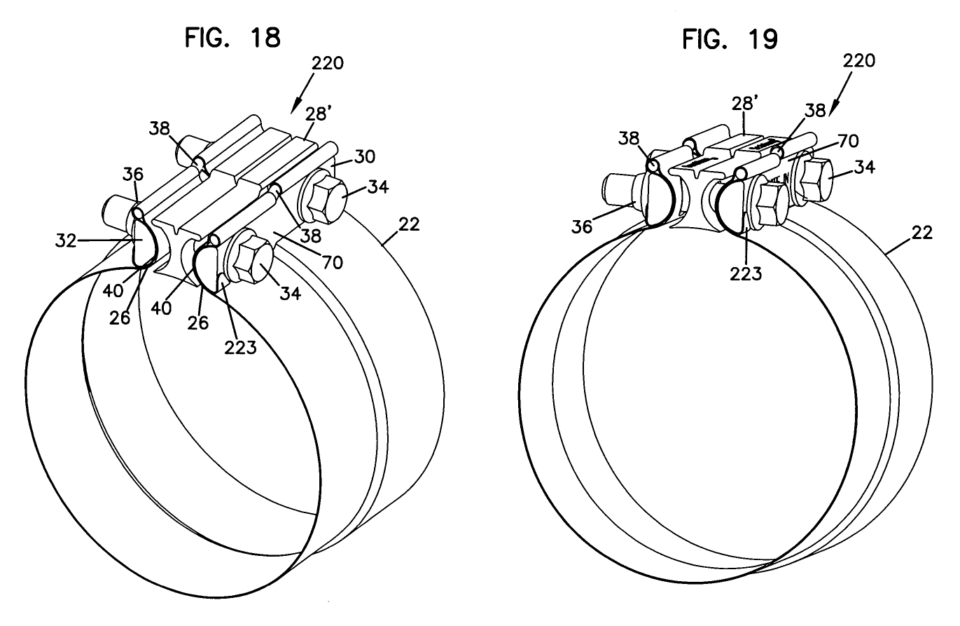

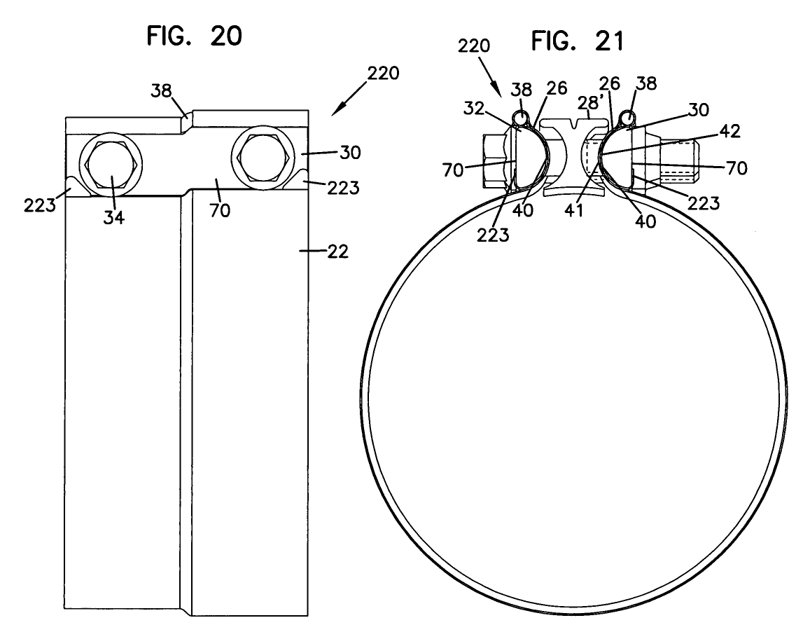

FIGS. 18-21 show another clamp 220 having features that are examples of inventive aspects conceived by the inventors. The 220 clamp includes the sealing bar 28′ of FIGS. 13-17. The clamp 220 also includes many of the same components as the clamp 20 of FIGS. 1A-1C. For example, the clamp 220 includes band 22 having flanges 26 defining pockets 40. The clamp 220 also includes outer reinforcing bars 30, 32 received in the pockets 40, and a fastening arrangement including nut bar 36 and two bolts 34, 134, 234. The flanges 26 of the clamp 220 are formed by doubling the ends of the band 24 over retaining bars 38 to provide inner and outer walls 41, 42 (see FIG. 21) at the flanges 26. The clamp 220 also includes structure for holding the outer reinforcing bars 30, 32 in the flange pockets 40 when the bolts 34, 134, 234 are not in place. As shown in FIGS. 18-22, the structure includes retaining portions 223 of the outer walls 42 of the flanges 26 that extend around the undersides of the outer reinforcing bars 30, 32 and project upwardly so as to oppose the flat outer surfaces 70 of the outer reinforcing bars 30, 32. The retaining portions 223 function to trap or capture the outer reinforcing bars 30, 32 within the pockets 40 of the flanges 26. As shown in FIGS. 18-21, the portions 223 include generally triangular tabs located adjacent the ends of the outer reinforcing bars 30, 32. Of course, other shaped structures could also be used. It will be appreciated that the clamp 220 can be manufactured in the same way described with respect to the clamp 20 of FIGS. 1A-1C, with the retaining portions 223 being bent upwardly to the retaining/trapping position after the outer reinforcing bars 30, 32 have been placed in the pockets 40.

e. Clamps Without Retaining Bars

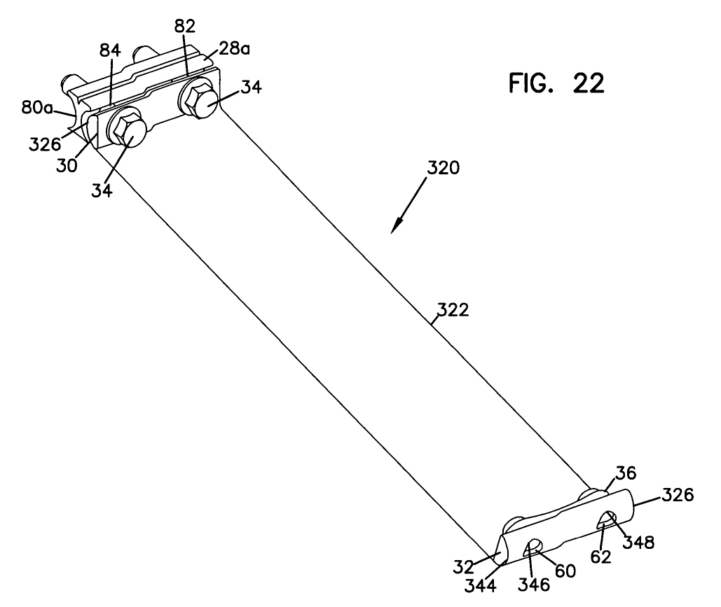

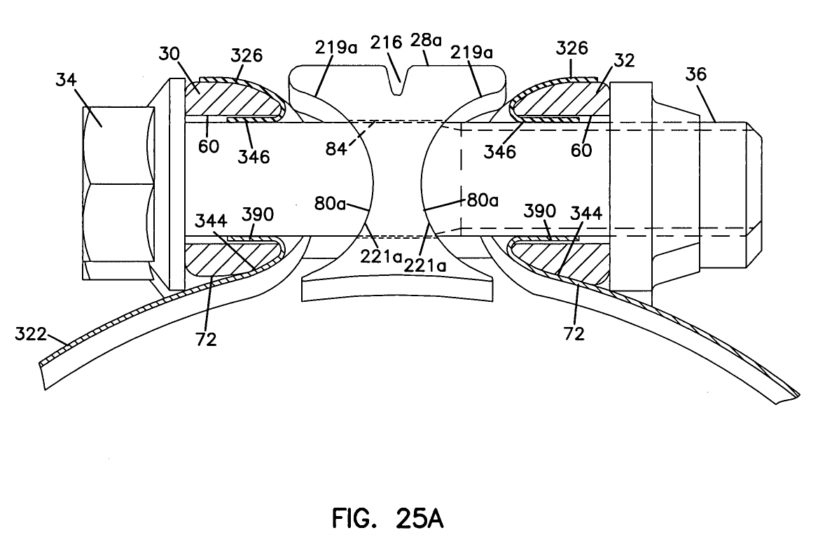

FIGS. 22-25A show a clamp 320 having features that are examples of inventive aspects conceived by the inventors. The clamp 320 includes a sealing bar 28a that is the same as the sealing bar 28′ of FIGS. 13-17 except the flats 219 have been replaced with curved surfaces 219a (see FIG. 25a). The curved surfaces 219a cooperate with curved surfaces 221a to define pockets 80a of the sealing bar 28a. The curved surfaces 219a, 221a have the same radiuses of curvature, but are arced about centerpoints that are offset from one another prior to tightening of the clamp and deformation of reaction legs 210a of the sealing bar 28a.

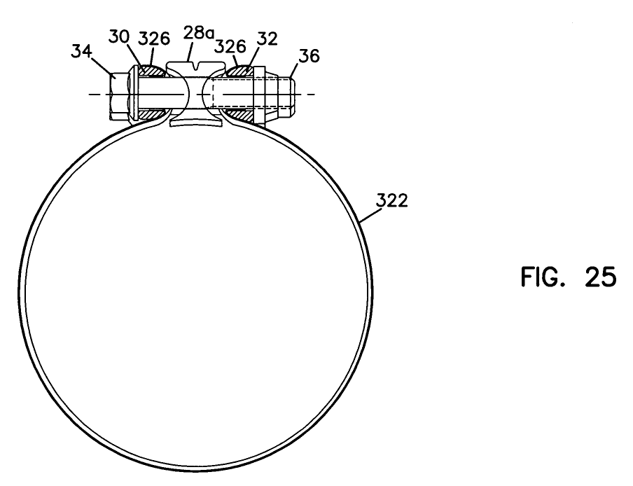

Similar to the clamp 20 of FIGS. 1A-1C, the clamp 320 also includes outer reinforcing bars 30, 32, bolts 34, 134, 234 and nut bar 36. Unlike the clamp 20 of FIGS. 1A-1C, the clamp 320 does not include retaining bars 38 over which the band is doubled over to form a mounting flange having a double-wall portion. Instead, the clamp 320 includes a band 322 having mounting flanges 326 defined by a single thickness or a single layer of the band 322. As best shown in FIGS. 24, 25 and 25A, the mounting flanges 326 define outwardly facing concave pockets 344 that receive the convex surfaces 72 of the outer reinforcing bars 30, 32. The flanges 326 fit within the pockets 80a of the sealing bar 28a. In use, the single layers forming the pockets 344 of the band 322 extend between the sealing bar 28a and the outer reinforcing bars 30, 32 (see FIGS. 25 and 25A). When the clamp is tightened, the reaction legs 210a deflect to accommodate the flanges 326 and the bars 30, 32 within the pockets 80a. As the reaction legs 210a deflect, notch 216 on the sealing bar 28a closes and the centerpoints of the curved surfaces 219a, 221a move toward one another. In a preferred embodiment, the curved surfaces 219a and 221a share a common centerpoint when the clamp is fully tightened.

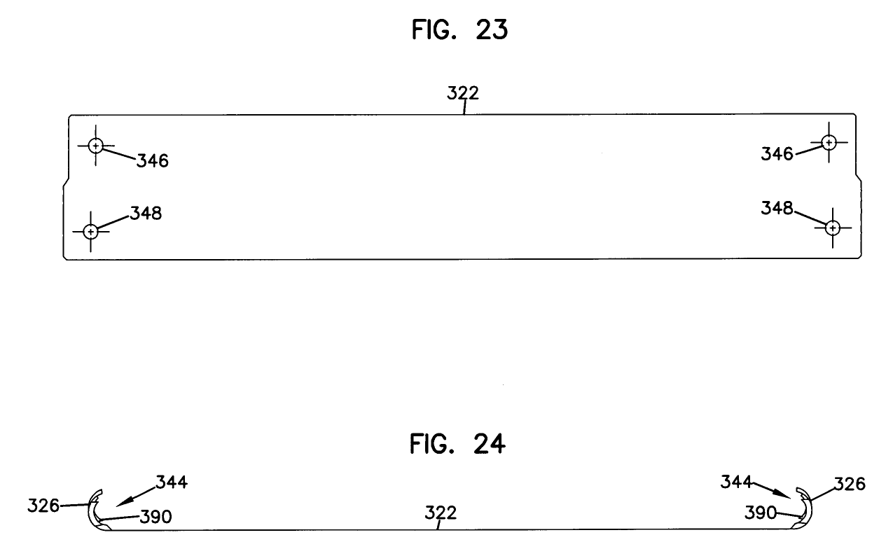

Referring to FIGS. 22 and 23, the band 322 includes two sets of bolt openings 346, 348. The bolt openings 346, 348 are staggered relative to one another to align with openings 60, 62 of the bars 30, 32 and openings 84, 82 of the sealing bar 28a. The bolt openings 346, 348 are preferably formed through a punching process that generates outwardly extending projections 390 (see FIGS. 24, 25 and 25A) that surround each of the bolt openings 346, 348 and project into the concave pockets 344. The projections 390 can also be referred to as “extension portions” or “necked portions.” During the manufacturing process, the projections 390 can be extruded into the corresponding openings 60, 62 defined by the outer reinforcing bars 30, 32 (see FIG. 25A where openings 60 are depicted). It will be appreciated that projections 390 corresponding to openings 348 extend into openings 62 in a similar manner and therefore have not been separately depicted. By extruding or otherwise extending the projections 390 into the openings 60, 62 of the reinforcing bars 30, 32, the openings 346, 348 of the band 322 resist tearing when the clamp 320 is tightened about a conduit.

In an alternative embodiment, the ends of the band 322 can be bent around a curved manufacturing tool to form the pockets 344. The curved manufacturing tool can include openings into which the projections 390 are punched during formation of the openings 346, 348. After the openings 346, 348 have been punched, the manufacturing tool is removed and the reinforcing bars 30, 32 are inserted in the pockets 344 with the projections 390 extending into the openings 60, 62 of the bars 30, 32.

It will be appreciated that the band 322 can be pre-formed into a generally cylindrical shape, or could have a flat configuration as shown in FIG. 22. The band 322 is preferably made of a relatively thin, ductile metal material such as stainless steel or aluminized steel. In one non-limiting embodiment of the present invention, the band 322 is made of stainless steel and has a wall thickness in the range of 0.013-0.023 inch.

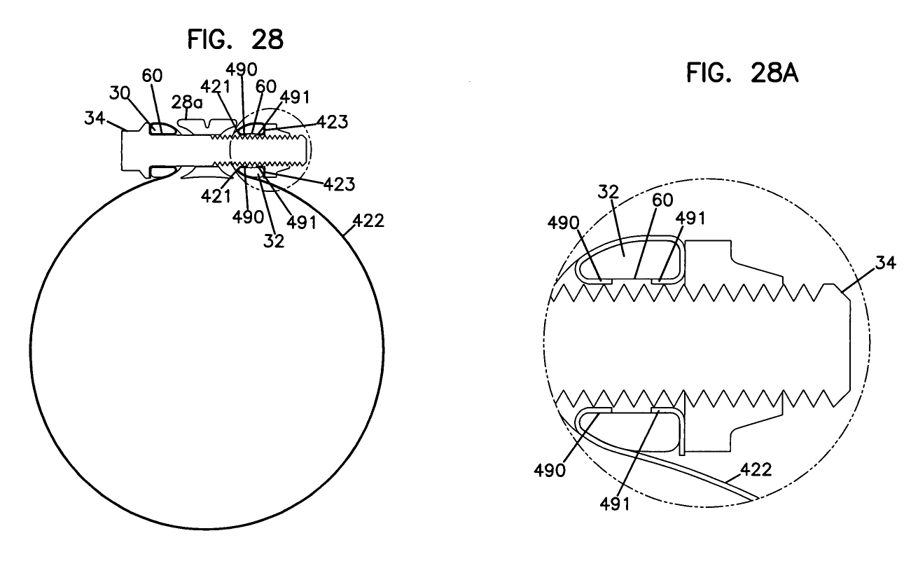

FIGS. 26-28A show another clamp 420 having features that are examples of inventive aspects conceived by the inventors. The clamp 420 lacks retaining bars 38 and has many of the same components as the clamp 320. For example, the clamp 420 includes sealing bar 28a, outer reinforcing bars 30, 32, bolts 34, 134, 234 and nut bar 36. A band 422 of the clamp has been modified to include retaining portions 423 that wrap over top sides of the of the outer reinforcing bars 30, 32 and oppose the flat sides 70 of the reinforcing bars 30, 32 to retain the bars 30, 32 within pockets 440 defined by flanges 426 of the band 422. The ends of the band 422 include slits 425 that facilitate bending the retaining portions 423 in a conformed manner over the stepped outer reinforcing bars 30, 32. A single thickness or layer 421 of the band 422 extends between the sealing bar 28a and each of the outer reinforcing bars 30, 32. As shown in FIGS. 28 and 28A, the band 422 include outwardly necked portions 490 that project into the inside ends of the openings 60 of the outer reinforcing bars 30, 32, and inwardly necked portions 491 that project into the outside ends of the openings 60 of the outer reinforcing bars 30, 32. Preferably, similar necked portions project into the other openings 62 defined by the outer reinforcing bars 30, 32. The outwardly necked portions 490 are integral with the layer 421, and the inwardly necked portions 491 are integral with the retaining portions 423.

By way of example, certain of the above clamp embodiments can include bands having a thickness in the range of 0.013-0.033 or 0.018-0.025 inch. Of course, the thickness will vary with intended use and other thicknesses are also contemplated. Also, any of the above embodiments disclosed herein can be packaged in a flat configuration as shown in FIGS. 11A and 11B, or a dipped configuration as shown in FIGS. 12A and 12B. Moreover, any of the embodiments disclosed herein can be used in combination with a sealing gasket as disclosed in U.S. patent application Ser. No. 10/387,705, entitled Sealing Gasket for a Clamp, filed on Mar. 13, 2003, which is hereby incorporated by reference in its entirety.

With regard to the foregoing description, it is to be understood that changes may be made in detail, especially with respect to the construction materials employed and the shape, size and arrangement of the parts without departing from the scope of the present invention. It is intended that the specification and depicted aspects be considered illustrative only with a true scope end spirit of the invention being indicated by the broad meaning of the following claims.

We claim:

1. A clamp comprising:
a band having a main body and outwardly facing pockets, the band defining at least two fastener openings at the outwardly facing pockets;
a sealing member that mounts between the outwardly facing pockets of the band, the sealing member having fastener openings that align with the fastener openings of the band;
reinforcing members that mount in the outwardly facing pockets of the band, the reinforcing members having fastener openings that align with the fastener openings of the band; and
bolts that pass through the fastener openings of the band, the fastener openings of the sealing member, and the fastener openings of the reinforcing members, the bolts having a threaded portion and an unthreaded shank, the threaded portion having an outer thread diameter greater than a diameter of the unthreaded shank.

2. The clamp of claim 1, wherein the outer thread diameter of the threaded portion is at least 0.02 inch larger than the diameter of the unthreaded shank.

3. The clamp of claim 2, wherein the outer thread diameter of the threaded portion is at least 0.03 inch larger than the diameter of the unthreaded shank.

4. The clamp of claim 1, wherein the outer thread diameter of the threaded portion is at least 5 percent larger than the diameter of the unthreaded shank.

5. The clamp of claim 1, wherein the sealing member includes concave surfaces that accept a portion of the band.

6. The clamp of claim 5, wherein the reinforcing members include convex surfaces that correspond to the concave surfaces of the sealing member.

7. The clamp of claim 1, wherein the band is doubled over the reinforcing members.

8. The clamp of claim 1, wherein the outer thread diameter of the bolts is larger than a diameter of the fastener openings of the sealing member.

9. The clamp of claim 8, wherein the unthreaded shanks are sized to provide a loose slip fit within the fastener openings of the sealing member.

10. The clamp of claim 8, wherein the outer thread diameter of the bolts is at least 0.004 inch larger than the diameter of the fastener openings of the sealing member.

11. The clamp of claim 8, wherein the outer thread diameter of the bolts is in the range of 0.004 to 0.007 inches larger than the diameter of the fastener openings of the sealing member.

12. The clamp of claim 8, wherein the fastener openings of the sealing member are tapered, and the diameter defined by the fastener openings of the sealing member comprises a minor diameter.

13. The clamp of claim 12, wherein the fastener openings of the sealing member define a cone angle greater than 3 degrees.

14. The clamp of claim 13, wherein the fastener openings of the sealing member define a cone angle greater than 4 degrees.

15. The clamp of claim 14, wherein the fastener openings of the sealing member define a cone angle greater than 6 degrees.

16. The clamp of claim 15, wherein the fastener openings of the sealing member define a cone angle of about 8 degrees.

17. A clamp comprising:
a band having a main body and outwardly facing pockets, the band defining at least two fastener openings at the outwardly facing pockets;
a sealing member that mounts between the outwardly facing pockets of the band, the sealing member having fastener openings that align with the fastener openings of the band, the fastener openings being tapered so as to have a major diameter at a first side of the sealing member and having a minor diameter at a second side of the sealing member, the taper defining a cone angle greater than 3 degrees; and
reinforcing members that mount in the outwardly facing pockets of the band, the reinforcing members having fastener openings that align with the fastener openings of the band.

18. The clamp of claim 17, wherein the cone angle is at least 4 degrees.

19. The clamp of claim 17, wherein the cone angle is at least 6 degrees.

20. The clamp of claim 17, wherein the cone angle is about 8 degrees.

21. The clamp of claim 17, further comprising bolts that pass through the fastener openings of the band, the fastener openings of the sealing member, and the fastener openings of the reinforcing members, the bolts having a threaded portion and an unthreaded shank, the threaded portion having a diameter greater than a diameter of the unthreaded shank and greater than the minor diameter of the fastener openings of the sealing member, the diameter of the threaded shank being less than the minor diameter of the fastener openings of the sealing member.

22. The clamp of claim 17, wherein the sealing member includes concave surfaces that accept a portion of the band.

23. The clamp of claim 22, wherein the reinforcing members include convex surfaces that correspond to the concave surfaces of the sealing member.

24. The clamp of claim 17, further comprising bolts that pass through the fastener openings of the band, the fastener openings of the sealing member, and the fastener openings of the reinforcing members, the bolts having a threaded portion having a diameter greater than the minor diameter of the fastener openings of the sealing member.

25. A clamp comprising:
a band having a main body and outwardly facing pockets, the band defining at least two fastener openings at the outwardly facing pockets;
a sealing member that mounts between the outwardly facing pockets of the band, the sealing member having fastener openings that align with the fastener openings of the band;
reinforcing members that mount in the outwardly facing pockets of the band, the reinforcing members having fastener openings that align with the fastener openings of the band; and
bolts that pass through the fastener openings of the band, the fastener openings of the sealing member, and the fastener openings of the reinforcing members, the bolts having threads defining an outer thread diameter greater than a diameter defined by the fastener openings of the sealing member, the sealing member including threads cut within the fastener openings of the sealing bar by threading the bolts through the fastener openings.

26. The clamp of claim 25, wherein the bolts have threaded portions and unthreaded shanks.

27. The clamp of claim 25, wherein the sealing member includes concave surfaces that accept a portion of the band.

28. The clamp of claim 27, wherein the reinforcing members include convex surfaces that correspond to the concave surfaces of the sealing member.

29. The clamp of claim 25, wherein the band is doubled over the reinforcing members.

30. The clamp of claim 25, wherein the outer thread diameter of the bolts is in the range of 0.004-0.011 inches larger than the diameter of the fastener openings of the sealing bar.

31. The clamp of claim 25, wherein the outer thread diameter of the bolts is in the range of 0.004-0.007 inches larger than the diameter of the fastener openings of the sealing bar.
